(19) United States
(12) Patent Application Publication
(10) Pub. No.: US 2011/0017524 A1
(43) Pub. Date: Jan. 27, 2011

(54) DUAL-SUBSTRATE CAPACITIVE TOUCH PANEL

(76) Inventors: Chien Lung Chen, Fengshan (TW); Wen-Jye Chen, Kaohsiung (TW); Neng-Sen Kao, Fengshan (TW); Chien-Cheng Chen, Fengshan (TW)

Correspondence Address: THE WEINTRAUB GROUP, P.L.C., 28580 Orchard Lake Road, Suite 140, Farmington Hills, MI, 48334, US

(21) Appl. No.: 12/509,782

(22) Filed: Jul. 27, 2009

(51) Int. Cl. G08C 21/00

(52) U.S. Cl. 178/18.06

(57) ABSTRACT

A touch panel has a first substrate, a second substrate, a frame adhesive and multiple multi-layer conductive wires. The first substrate has first axis electrode strings and second axis transparent electrodes formed on a surface. The second substrate is disposed opposite to the first substrate and has bridging members and bridging connectors formed on each of the bridging members and connected to the second axis electrodes of the first substrate. The frame adhesive connects the first substrate and the second substrate. The multi-layer conductive wires are electrically connected to the first axis electrode strings and the second axis transparent electrodes and connect to a flexible printed circuit board. With the bridging members and bridging connectors formed on another substrate, a mask process of forming insulating members can be avoided, and a manufacture process is simplified with associated cost reductions.

### BACKGROUND OF THE INVENTION

1. Field of the Invention

The present invention relates to a touch panel, especially to a dual-substrate capacitive touch panel with multi-layer conductive wires and bridging structures.

2. Description of the Related Art

Capacitive touch panels may be divided into single-substrate touch panels and dual-substrate touch panels depending upon the number of substrates a touch panel has. A single-substrate touch panel is formed by stacking different thin films on a substrate via several processes. A dual-substrate touch panel is configured with a top substrate and a bottom substrate. No matter whether a capacitive touch panel is formed as a single-substrate type or as a dual-substrate type, the capacitive touch panel often has multiple electrode strings in two different axial directions.

With reference to FIGS. 10, 11 and 12, a conventional touch panel in a single-substrate type has a substrate (70), multiple X-axis electrode strings (71), multiple Y-axis electrodes (72), multiple connection wires (73) and a flexible printed circuit board (77). The X-axis electrode strings (71), the Y-axis electrodes (72) and the connection wires (73) are printed on the substrate (70). The Y-axis electrodes (72) form multiple Y-axis electrode strings, wherein the Y-axis electrodes (72) of each Y-axis electrode string are electrically connected to each other via multiple bridging members (74). In order to prevent the bridging member (74) from contacting the X-axis electrode strings (71) and causing a short circuit, an insulation member (76) is disposed between a bridging member (74) and each X-axis electrode string (71). The connection wires (73) connect the electrode strings (71, 72) and the flexible printed circuit board (77).

With a dual-substrate structure, the touch panel has two opposite substrates, multiple X-axis electrode strings disposed on one substrate and multiple Y-axis electrode strings disposed on the other substrate and facing the X-axis electrode strings. Each X-axis electrode string has multiple X-axis electrodes and multiple conductive wires that connect the X-axis electrodes in a line. Each Y-axis electrode string has multiple Y-axis electrodes and multiple conductive wires connecting the Y-axis electrodes in a line. In order to avoid a short circuit, multiple insulation members are respectively disposed on the stacked positions between the X-axis electrode strings and the Y-axis electrode strings.

Generally speaking, a conventional manufacturing process of a single-substrate capacitive touch panel has at least three mask processes comprising:
A. A first mask process of forming X-axis electrodes, X-axis connection wires, Y-axis electrodes;
B. A second mask process of forming insulation members; and
C. A third mask process of forming bridging members.

Because of the additional mask process of forming the insulation members, the manufacturing process of the touch panel is more complicated with associated higher costs.

Besides, the connection wires (73) are used for transmitting signals from the electrode strings (71, 72) to the flexible printed circuit board (77) and are often made of metallic materials to reduce resistance in transmission. However, those metallic connection wires (73) have the following shortcomings:
1. Since the electrodes of the electrode strings (71, 72) are usually made of transparent conductive materials, such as Indium tin oxide (ITO), which differ from the metallic connection wires (73), adhesion of the junction of an electrode and a connection wire (73) is fragile.
2. Since resistance value of each X-axis electrode string differs from the resistance value of each Y-axis electrode string, the sensitivity of the X-axis electrode strings differs from the sensitivity of the Y-axis electrode strings. Such resistance difference becomes bigger when it comes to a larger size touch panel. Resistance of the metallic connection wires (73) is hard to adjust due to inherent characteristics of metal. Even though connection wires (73) can be changed in length or width, adjustment effects that can be attained are still limited.
Therefore, it is hard to use the connection wires (73) to attain an adjustment on resistance value of an electrode string to compensate for resistance difference.

To overcome the shortcomings, the present invention provides a dual-substrate capacitive touch panel to mitigate or obviate the aforementioned problems.

### SUMMARY OF THE INVENTION

The main objective of the present invention is to provide a dual-substrate capacitive touch panel with multi-layer conductive wires and bridging structures.

The touch panel comprises a first substrate, a second substrate, a frame adhesive and multiple multi-layer conductive wires.

The first substrate has multiple first axis electrode strings and multiple second axis transparent electrodes formed on a surface of the first substrate.

The second substrate is disposed opposite to the first substrate and has multiple bridging members and multiple bridging connectors formed on a surface of the second substrate. The bridging connectors are formed on each of the bridging members and connected to the second axis electrodes of the first substrate.

The frame adhesive is formed between edges of the surfaces of the first substrate and the second substrate, receives multiple hard spacers and connects the first substrate and the second substrate to form a sealed chamber between the first and the second substrates. The chamber is spread with multiple elastic spacers and filled with optical adhesive.

The multi-layer conductive wires are mounted on the surface of the first substrate or the second substrate, electrically connected to the first axis electrode strings and the second axis transparent electrodes and connects to a flexible printed circuit board. Each multi-layer conductive wire comprises multiple stacked conductors with different resistance values.

With the bridging members and bridging connectors formed on another substrate, a mask process of forming insulating members can be avoided, and a manufacture process is simplified with associated costs reductions. Besides, resistance difference between the electrode strings can be compensated by adjusting length and width of the multi-layer conductive wires, hence sensitivity of the X-axis electrode strings and Y-axis electrode strings are more consistent with each other.

Other objectives, advantages and novel features of the invention will become more apparent from the following detailed description when taken in conjunction with the accompanying drawings.

### BRIEF DESCRIPTION OF THE DRAWINGS

FIG. 1A is a plan view of a first substrate of a first embodiment of a dual-substrate capacitive touch panel in accordance with the present invention;

FIG. 1B is a plan view of a second substrate of the first embodiment of the dual-substrate capacitive touch panel in accordance with the present invention;

FIG. 2 is a cross sectional view of the first substrate taken along line 2-2 in FIG. 1A;

FIG. 3 is a plan view of a combination of the first and the second substrates in FIGS. 1A and 1B;

FIG. 4 is a cross sectional view of the substrates in FIG. 3;

FIG. 5A is a plan view of a first substrate of a second embodiment of a dual-substrate capacitive touch panel in accordance with the present invention;

FIG. 5B is a plan view of a second substrate of the second embodiment of the dual-substrate capacitive touch panel in accordance with the present invention;

FIG. 6 is a cross sectional view of the first and second substrates in FIGS. 5A and 5B;

FIG. 7A is a plan view of a first substrate of a third embodiment of a dual-substrate capacitive touch panel in accordance with the present invention;

FIG. 7B is a plan view of a second substrate of the third embodiment of the dual-substrate capacitive touch panel in accordance with the present invention;

FIG. 8 is a partial cross sectional view of a fourth embodiment of a dual-substrate capacitive touch panel in accordance with the present invention;

FIG. 9 is a partial cross sectional view of a fifth embodiment of a dual-substrate capacitive touch panel in accordance with the present invention;

FIG. 10 is a plan view of a conventional single-substrate capacitive touch panel;

FIG. 11 is a partial cross sectional view of the conventional single-substrate capacitive touch panel in FIG. 10; and

FIG. 12 is a cross sectional view taken along a line 12-12 in FIG. 10.

### DETAILED DESCRIPTION OF THE PREFERRED EMBODIMENTS

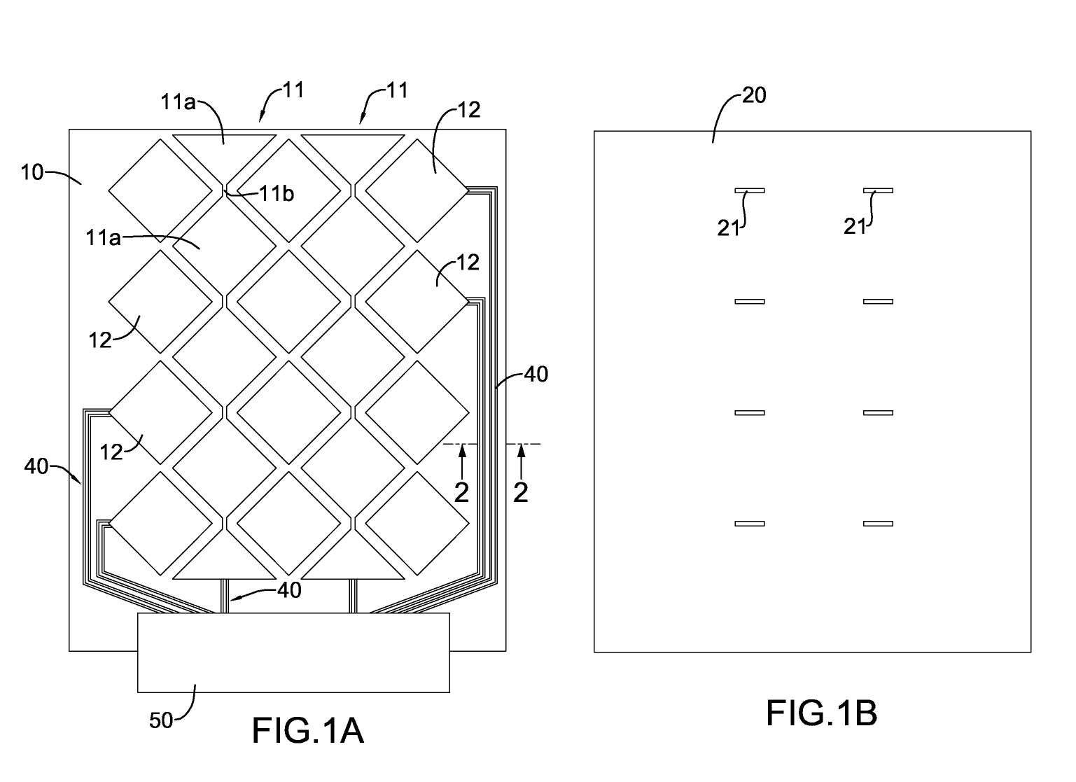

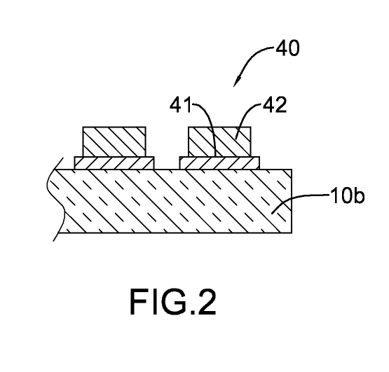

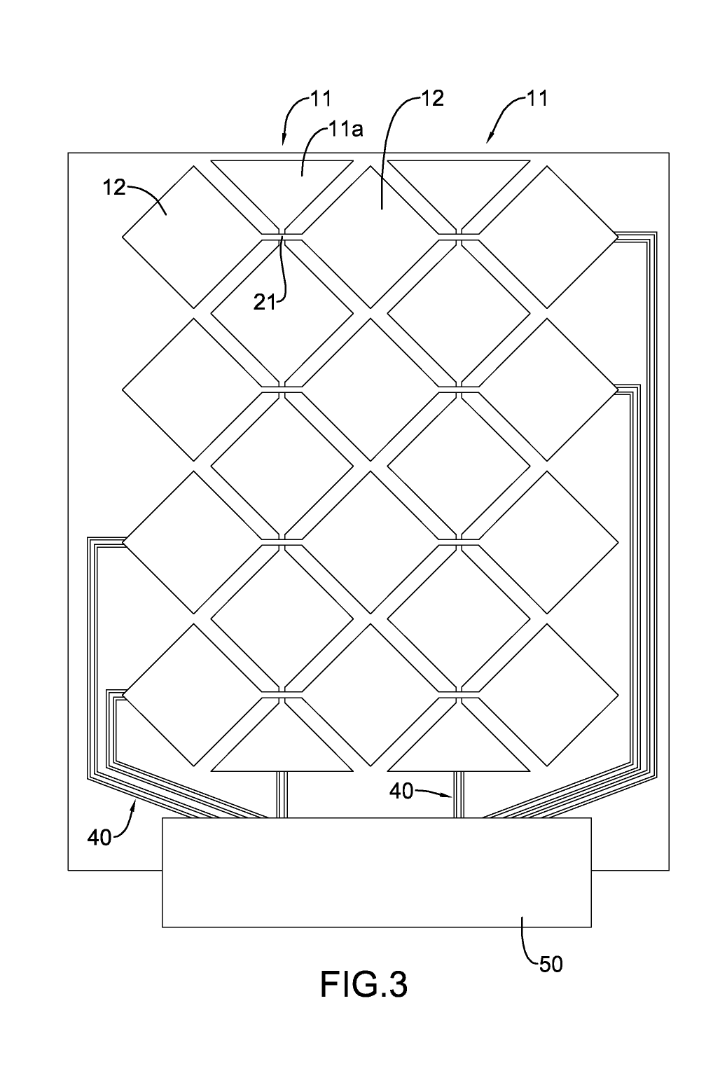

With reference to FIGS. 1A, 1B and 2 to 4, a first embodiment of a dual-substrate capacitive touch panel in accordance with the present invention comprises a first substrate (10), a second substrate (20), a frame adhesive (30) and multiple multi-layer conductive wires (40).

The first substrate (10) may be made of glass, plastic or flexible transparent material. In the first embodiment, the first substrate (10) is an upper substrate and has a bottom surface, multiple first axis electrode strings (11) and multiple second axis transparent electrodes (12), wherein the first axis electrode strings (11) and the second axis transparent electrodes (12) are formed on the bottom surface. In the first embodiment, the first axis electrode strings (11) are X-axis electrode strings that comprise multiple X-axis transparent electrodes (11a) and multiple X-axis connection wires (11b) connecting the X-axis transparent electrodes (11a). The second axis transparent electrodes (12) are Y-axis transparent electrodes. Alternatively the first axis electrode strings (11) can be implemented as Y-axis electrode strings that comprise multiple Y-axis transparent electrodes and multiple Y-axis connection wires connecting the Y-axis transparent electrodes, and the second axis transparent electrodes (12) can be implemented as X-axis transparent electrodes.

The second substrate (20) is disposed opposite to the first substrate and may be made of glass, plastic or flexible transparent material. In the first embodiment of the present invention, the second substrate (20) is a lower substrate and has a top surface, multiple bridging members (21) and multiple bridging connectors (22). The top surface of the second substrate (20) faces the bottom surface of the first substrate (10). The bridging members (21) and the bridging connectors (22) are formed on the top surface and may be formed by screen printing. The bridging members (21) are respectively disposed across the connection wires (11b) and may be implemented as transparent electrodes, such as indium tin oxide electrodes. The bridging connectors (22) on each bridging member (21) are transparent conductors and connect two adjacent second axis transparent electrodes (12), and thereby form multiple second axis electrode strings.

The frame adhesive (30) is formed between edges of the surfaces of the first substrate (10) and the second substrate (20), receives multiple hard spacers (31) and connects the first substrate (10) and the second substrate (20) to form a sealed chamber between the first and the second substrates (10, 20). The chamber may be spread with multiple elastic spacers (32) and filled with optical adhesive (33). The hard spacers (31) uniformly sustain the gap interval between the first and the second substrates (10, 20) and may be configured in any shape. The elastic spacers (32) may be implemented as adhesive spacers, dis-adhesive spacers or other spacers that are used in a printing or spray process. The elastic spacers (32) also aid sustaining the gap interval between the first and the second substrates (10, 20). The optical adhesive (33) is insulating and prevents outlines of transparent electrodes from emerging on overall screen display.

The multi-layer conductive wires (40) are formed on the surface of first substrate (10) or the second substrate (20), are electrically connected to the first axis electrode strings (11) and the second axis transparent electrodes (12) and connect to a flexible printed circuit board (50). Each multi-layer conductive wire (40) comprises multiple stacked conductors with different resistance values. The conductors may be implemented as Indium tin oxide electrodes. In the first embodiment, each multi-layer conductive wire (40) is formed on the surface of the first substrate (10) and has a double-layer structure configured by an inner conductor (41) and an outer conductor (42), wherein the inner conductor (41) has a relatively higher resistance value and lower thickness than the outer conductor (42) formed on the top of the inner conductor (41). Alternatively, the inner conductor (41) may have a lower resistance value than the outer conductor (42). The inner and outer conductors (41, 42) have different resistance values and substantially reduce an equivalent resistance value of the multi-layer conductive wire.

With the first substrate (10) having the first axis electrode strings (11) and second axis transparent electrodes (12) and the second substrate (20) having the bridging members (21) and the bridging connectors (22), combining the substrates (10, 20) to form the dual-substrate capacitive touch panel does not require insulating members to isolate the bridging member (21) from first axis electrode strings (11). Since the mask process of forming insulating members can be avoided, the manufacture process is simplified and costs reduced.

Furthermore, the multi-layer conductive wires (40) have low resistance values as a metallic wire and can transmit signals without attenuating signals. Because the multi-layer conductive wires (40), the first axis electrode strings (11) and the second axis transparent electrodes (12) are all made of transparent electrode material, such as ITO (indium tin oxide), adhesion of a junction of the multi-layer conductive wires (40) and the first axis electrode strings (11) or the second axis transparent electrodes (12) is firm, as required. Besides, resistance difference between the first and second axis electrode strings can be compensated by adjusting length and width of the multi-layer conductive wires (40), thereby the sensitivity of the X-axis electrode strings and Y-axis electrode strings can be more consistent with each other.

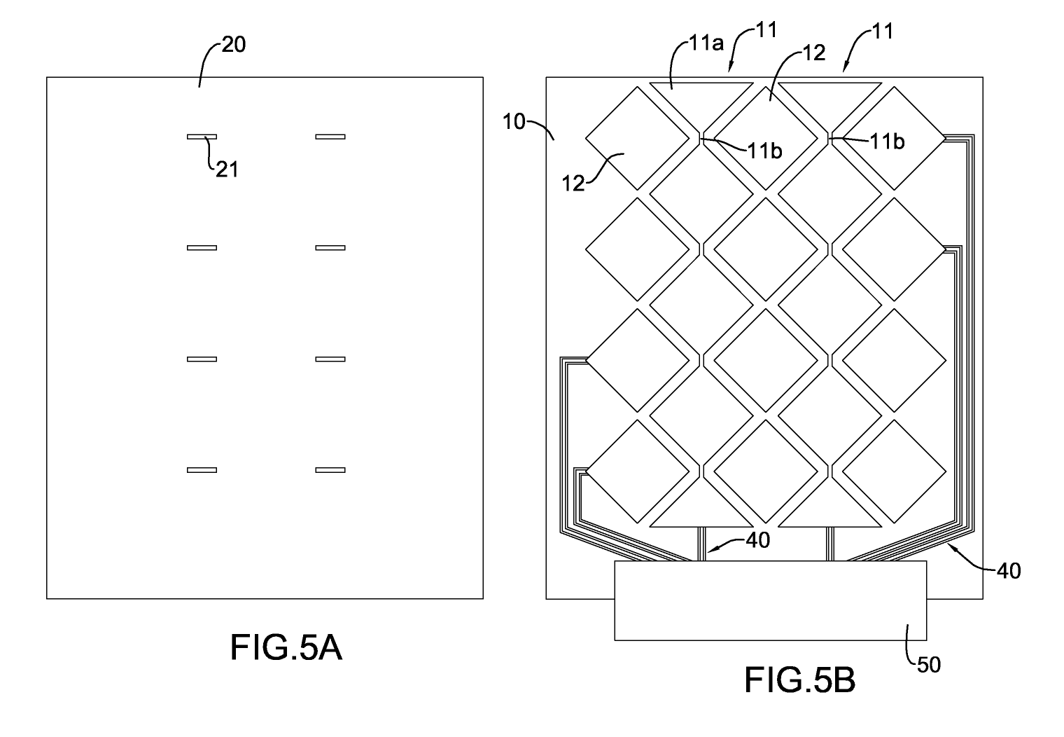

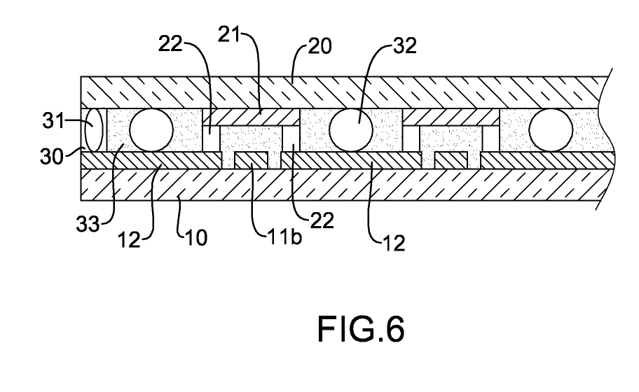

With further reference to FIGS. 5A, 5B and 6, in a second embodiment of the present invention, the first substrate (10) is a lower substrate having a top surface and the second substrate (20) is an upper substrate having a bottom surface, wherein the first axis electrode strings (11) and the second axis transparent electrodes (12) are formed on the top surface of the lower substrate and the bridging members (21) are formed on the bottom surface of the upper substrate.

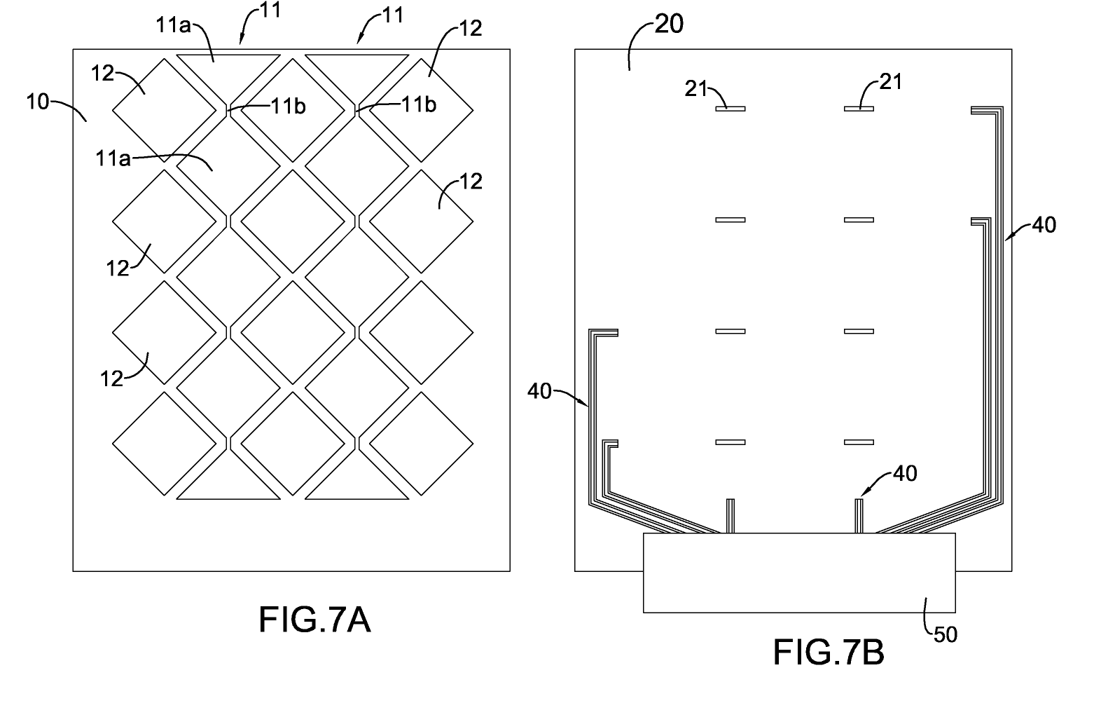

With further reference to FIGS. 7A and 7B, a third embodiment of the present invention is substantially similar in structure to the first embodiment in FIGS. 1A and 1B, wherein the multi-layer conductive wires (40) are formed on the second substrate (20).

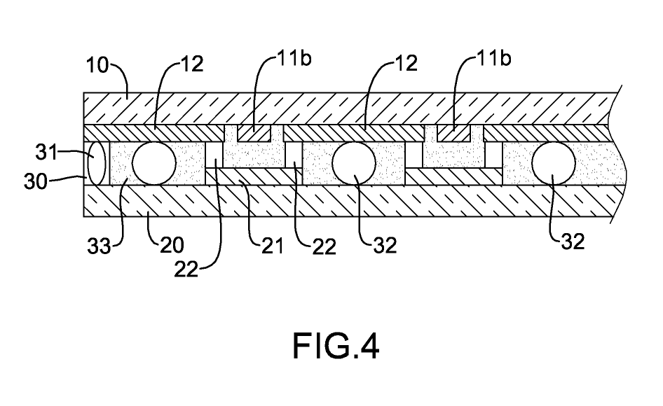

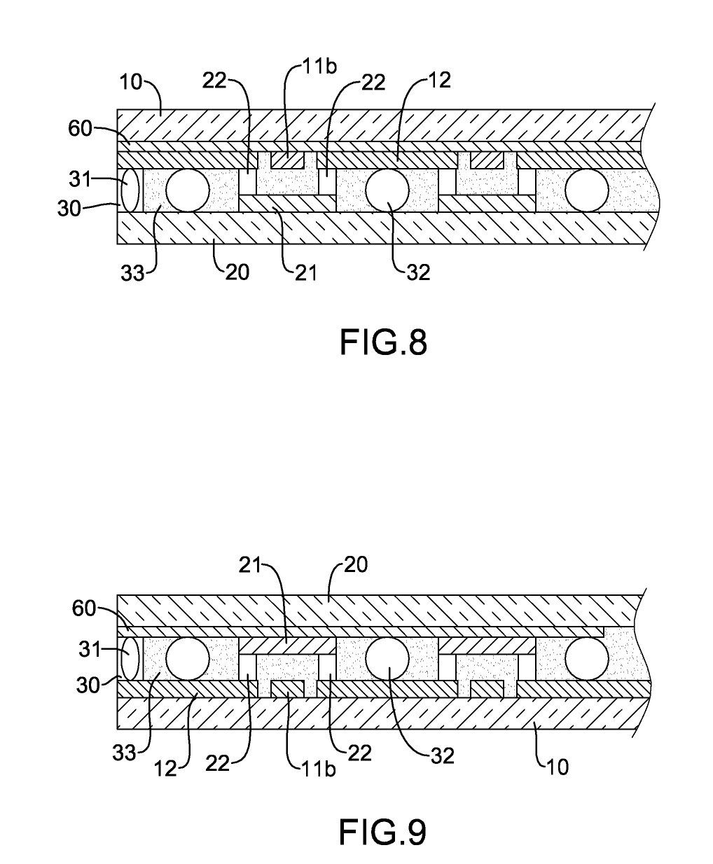

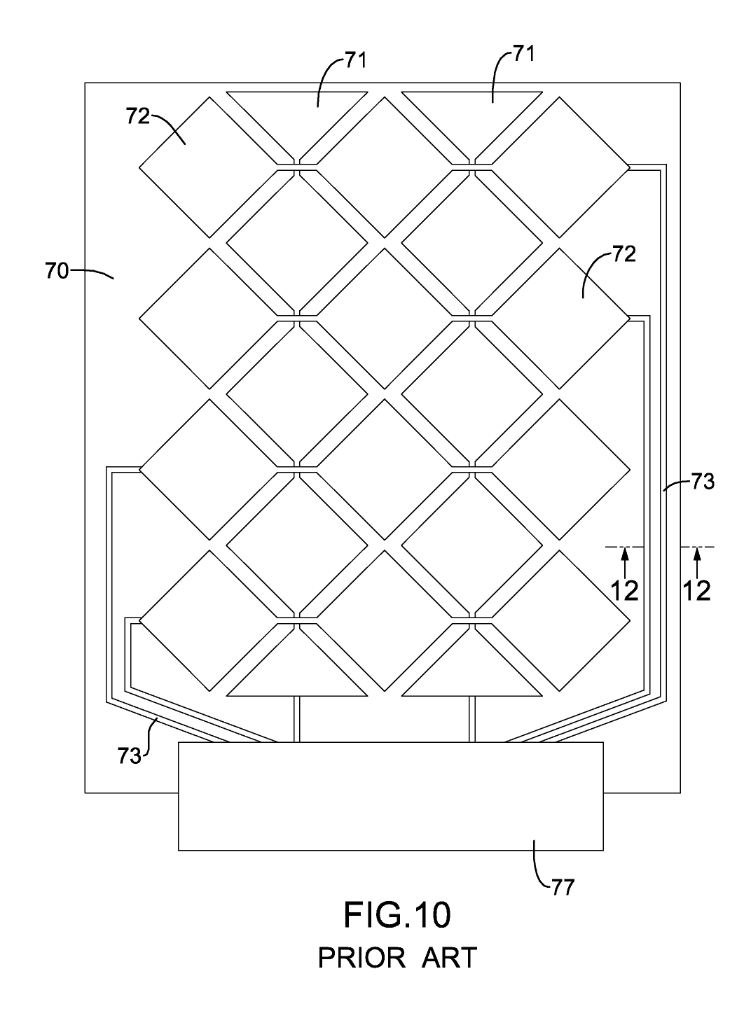

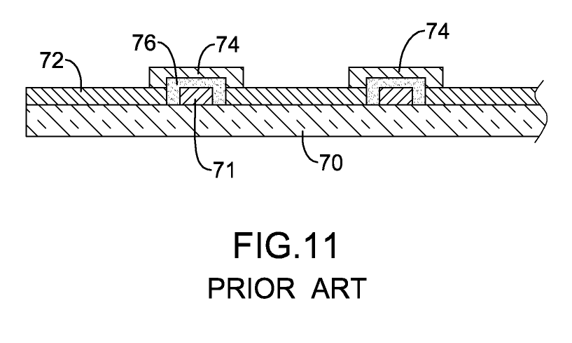

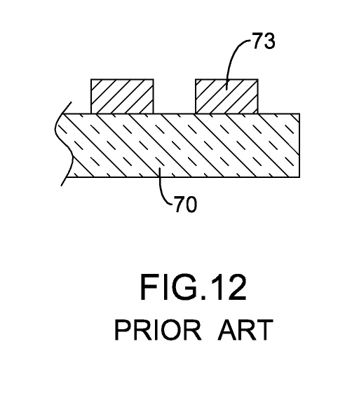

With further reference to FIGS. 8 and 9, the dual-substrate capacitive touch panel in FIG. 4 or FIG. 6 may further comprise a pattern layer (60). The pattern layer (60) is formed on a bottom surface of an upper substrate and may be implemented as a black matrix layer or a metallic layer.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A dual-substrate capacitive touch panel comprising:
a first substrate having
a surface;
multiple first axis electrode strings formed on the surface; and
multiple second axis transparent electrodes formed on the surface;
a second substrate disposed opposite to the first substrate and having
a surface facing the surface of the first substrate; and
multiple bridging members formed on the surface of the second substrate; and
multiple bridging connectors formed on each of the bridging members and connected to the second axis electrodes of the first substrate;
frame adhesive formed between edges of the surfaces of the first substrate and the second substrate, receiving multiple hard spacers and connecting the first substrate and the second substrate to form a sealed chamber, wherein the chamber is spread with multiple elastic spacers and filled with optical adhesive; and
multiple multi-layer conductive wires electrically connected to the first axis electrode strings and the second axis transparent electrodes and each multi-layer conductive wire comprising multiple stacked conductors with different resistance values.

2. The dual-substrate capacitive touch panel as claimed in claim 1, wherein the multi-layer conductive wires are formed on the surface of the first substrate.

3. The dual-substrate capacitive touch panel as claimed in claim 1, wherein the multi-layer conductive wires are formed on the surface of the second substrate.

4. The dual-substrate capacitive touch panel as claimed in claim 1, wherein
the first substrate is an upper substrate having a bottom surface;
the first axis electrode strings and the second axis transparent electrodes are formed on the bottom surface of the upper substrate;
the second substrate is a lower substrate having a top surface; and
the bridging members with bridging connectors are formed on the top surface of the lower substrate.

5. The dual-substrate capacitive touch panel as claimed in claim 1, wherein
the first substrate is a lower substrate having a top surface;
the first axis electrode strings and the second axis transparent electrodes are formed on the top surface of the lower substrate;
the second substrate is an upper substrate having a bottom surface; and
the bridging members with bridging connectors are formed on the bottom surface of the upper substrate.

6. The dual-substrate capacitive touch panel as claimed in claim 1, wherein
the first axis electrode strings are X-axis electrode strings comprising multiple X-axis transparent electrodes and multiple X-axis connection wires connecting the X-axis transparent electrodes; and
the second axis transparent electrodes are Y-axis transparent electrodes.

7. The dual-substrate capacitive touch panel as claimed in claim 1, wherein
the first axis electrode strings are Y-axis electrode strings comprising multiple Y-axis transparent electrodes and multiple Y-axis connection wires connecting the Y-axis transparent electrodes; and
the second axis transparent electrodes are X-axis transparent electrodes.

8. The dual-substrate capacitive touch panel as claimed in claim 4 further comprising a pattern layer formed on the lower surface of the upper substrate.

9. The dual-substrate capacitive touch panel as claimed in claim 5 further comprising a pattern layer formed on the lower surface of the upper substrate.

10. The dual-substrate capacitive touch panel as claimed in claim 8, wherein the pattern layer is a black matrix layer.

11. The dual-substrate capacitive touch panel as claimed in claim 9, wherein the pattern layer is a black matrix layer.

12. The dual-substrate capacitive touch panel as claimed in claim 8, wherein the pattern layer is a metallic layer.

13. The dual-substrate capacitive touch panel as claimed in claim 9, wherein the pattern layer is a metallic layer.

14. The dual-substrate capacitive touch panel as claimed in claim 1, wherein the stacked conductors are transparent electrodes.

15. The dual-substrate capacitive touch panel as claimed in claim 1, wherein each multi-layer conductive wire has a double-layer structure configured by an inner conductor and an outer conductor.
